(19) United States
(12) Patent Application Publication
(10) Pub. No.: US 2009/0266246 A1
(43) Pub. Date: Oct. 29, 2009

(54) Puzzle apple slicer

(76) Inventor: Lance Hood, Seattle, WA (US)

Correspondence Address: JOHN R. BENEFIEL, 525 Lewis Street, BIRMINGHAM, MI, 48009, US

(21) Appl. No.: 12/150,121

(22) Filed: Apr. 24, 2008

(51) Int. Cl. A47J 25/00; B26D 1/00

(52) U.S. Cl. 99/565; 30/113.1; 83/13

(57) ABSTRACT

A puzzle apple slicer which cuts an apple or similar fruit or vegetable portions thereof into wedges by radial blades each having a protrusion forming interfit channels and ridges in adjacent sides of the wedges to interlock the wedges together.

### BACKGROUND OF THE INVENTION

This invention concerns apple cutters or slicers of a type which cuts an apple into wedge shaped pieces and also cores the apple. Such apple slicers have long been known, as described in U.S. Pat. No. 1,466,114, D432,874 and D1114,471. Sliced apples are often prepared for children, and it is an object of the present invention to provide an apple slicer which cuts apples into specially shaped wedges in a way calculated to provide interest for the enjoyment of children and others.

### SUMMARY OF THE INVENTION

The above recited object as well as other objects which will become apparent upon a reading of the following specification and claims are achieved by a slicer tool for wedging apples or other fruits or vegetable comprised of a series of radial blades held in a holder grip having an opening through which an apple or other item to be sliced can pass. Each blade is formed with an open looped segment projecting laterally of a main portion of the blade which cut corresponding complementary channel and projection features into the apple wedges extending axially on adjacent sides of wedges into which the apple is sliced. These features are interfit to interlock the wedges to each other creating a three dimensional puzzle from the sliced apple wedges which are taken apart by relative sliding movement in an axial direction.

A central ring attached to inner ends of the blades can also be included to simultaneously core the apple in conventional fashion.

The holder grip preferably takes the form of an annular hard plastic ring into which the ends of the slicer steel blades are molded, with an overmolded outer grip layer of a softer elastomeric material.

### DESCRIPTION OF THE DRAWINGS

FIG. 1 is a pictorial view of a puzzle apple slicer according to the present invention.

FIG. 2 is an exploded pictorial view of the slicer blade set included in the apple slicer shown in FIG. 1.

FIG. 3 is a plan view of a blade piece included in the apple slicer of FIG. 1 which forms two of the radial cutter blades according to the present invention with a coring ring outline depicted in phantom lines.

FIG. 4 is a plan view of the puzzle apple slicer shown in FIG. 1.

FIG. 5 is a view of the radial section 5-5 taken in FIG. 4.

FIG. 6 is a pictorial view of an apple sliced into interlocked wedges with the use of an apple slicer tool according to the invention.

FIG. 6A shows the sliced apple of FIG. 6 with some of the wedges axially displaced from each other.

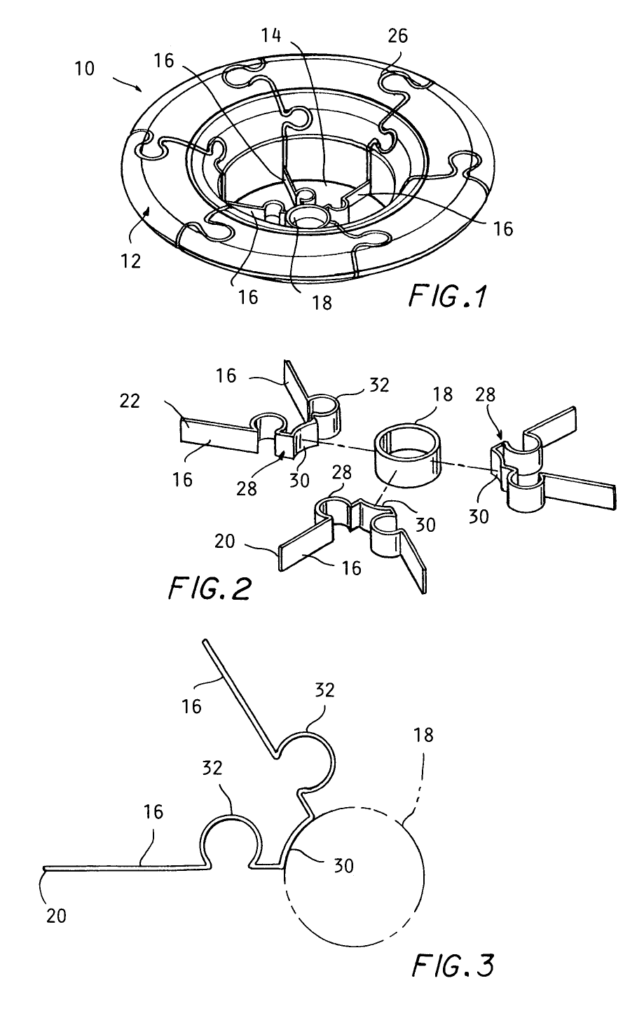

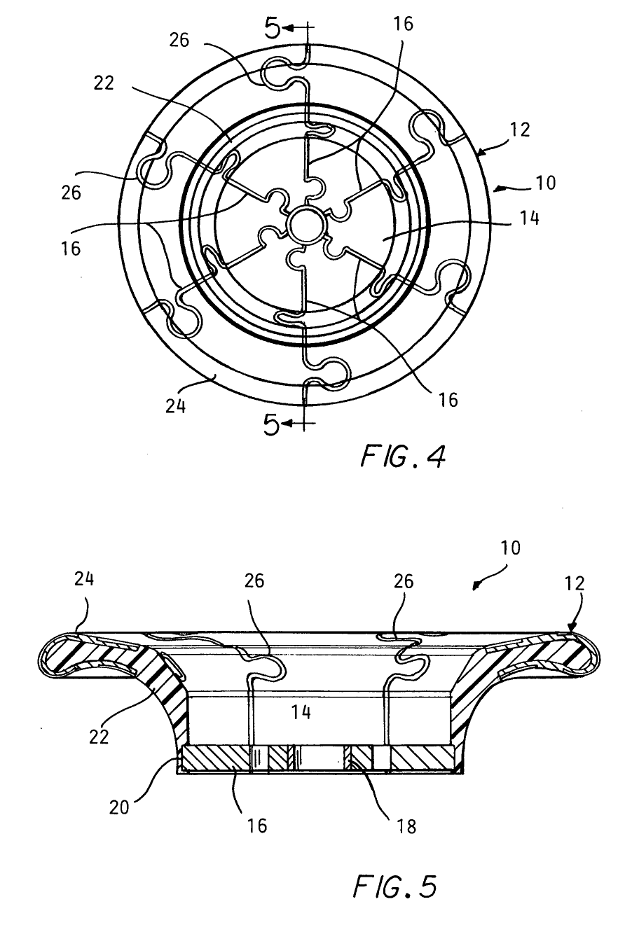

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

Referring to FIG. 1, the puzzle apple slicer 10 according to the present invention comprises a generally annular holder grip 12 having a central opening 14 sized to allow apples or other similarly sized fruits or vegetables to pass through, i.e. on the order of four inches in diameter.

An evenly spaced array of six radially extending slicer blades 16 each preferably made of stainless steel is disposed within the opening 14 affixed at their inner ends to a casing ring 18. The outer ends 20 are embedded in the holder grip 12. The holder grip 12 includes an inner holder body 22 molded of a tough molded plastic such as ABS to securely anchor the outer ends 20 of the blades 18.

An overmold layer 24 of a softer elastomeric material such a TPE enclosed the outer regions of the holder body 20 providing a better gripping surface. An embossed pattern 26 similar to the shape of the slicer blades 16.

The six slicer blades 16 are advantageously formed by three double bladed pieces 28 connected by a curved segment 30 matched to the outside diameter of the ring 18, which are spot welded to the ring 18 to form a unitary blade assembly.

According to the present invention, each blade 16 is formed with a circumferentially extending protrusion feature 32, here shown as in a partially circular shape intermediate the length of the main straight portion of each blade 16.

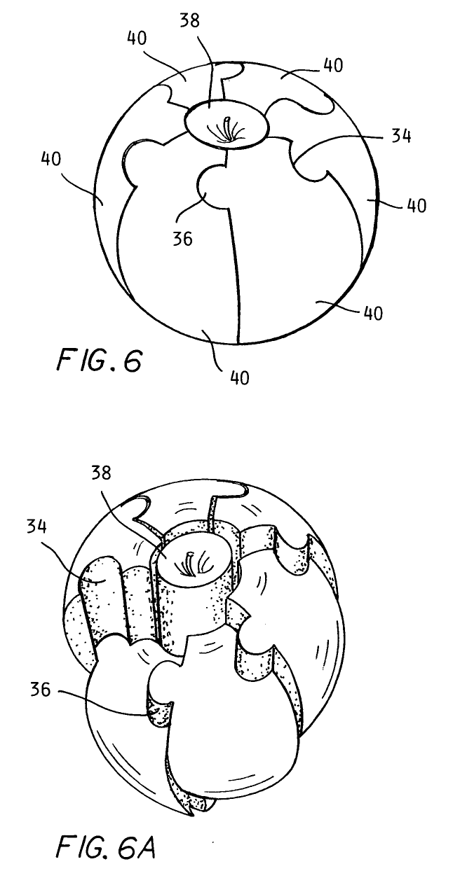

The features 32 simultaneously cut matched channels 34 and ridges 36 into the apple 38 (FIGS. 6, 6A) as well as the core plug 38 cut by ring 18.

Since the features 36 are partially circularly shaped, and preferably are greater than semicircle, the channels 34 and ridges 36 interlock to each other to resist pulling away from each other. Thus, the interfit cut wedges 40 are held together thereby but may be disassembled by axial sliding movement as seen in FIG. 6A.

This provides a three dimensional puzzle for amusement of children and others.

The apple wedges 40 are also uniquely shaped for decorative effect in fruit salads, etc.

Other fruits such as pears or portions of fruit such as melons may be sliced using the apple slicer. According to the invention or vegetables such as potatoes.

1. A slicer comprising:
a generally annular holder-grip having a central opening;
an array of radially extending slicer blades mounted within said central opening, each blade having a protrusion feature formed along the length of each blade, creating a corresponding channel and ridge in adjacent sides of apple wedges into which an apple sliced by said array of blades in being forced through said central opening.

2. The slicer according to claim 1 wherein each of said protrusion features is partially circular in shape.

3. The slicer according to claim 2 wherein said circular shape is greater than one half of a circle.

4. The slicer according to claim 1 further including a coring ring fixed to an inner end of each blade.

5. The slicer according to claim 4 wherein a set of three blade pieces are included each including two blades connected at inner ends by a curved segment matched to an outer surface of said coring ring and fixed abutted against said coring ring.

6. The slicer according to claim 1 wherein said holder grip is of molded plastic having outer ends embedded in said holder grip.

7. The slicer according to claim 6 wherein an overmolded layer extends over an outer grip portion of said holder grip of a softer elastomeric then a molded plastic holder body included in said holder grip

8. A method of slicing a fruit or vegetable into interlocked wedges comprising:
forming a protrusion into each of a series of slicer blades;
fixing said blades in a radial array;
and, forcing said blades through said fruit or vegetable to form wedges interlocked together by interfit channels and ridges cut into adjacent wedges of said fruit.

9. The method according to claim 8 wherein said protrusions are partially circularly shaped.

10. The method according to claim 9 wherein said protrusions each form a greater than a half circle to interlock said channels and ridges.
